(19) United States
(12) Patent Application Publication
(10) Pub. No.: US 2021/0209938 A1
(43) Pub. Date: Jul. 8, 2021

(54) METHOD, APPARATUS, SYSTEM, AND COMPUTER-READABLE MEDIUM FOR TRAFFIC PATTERN PREDICTION

(71) Applicant: Beijing Baidu Netcom Science and Technology Co., Ltd., Beijing (CN)

(72) Inventors: Xinjiang Lu, Beijing (CN); Dejing Dou, Beijing (CN)

(21) Appl. No.: 17/208,830

(22) Filed: Mar. 22, 2021

(30) Foreign Application Priority Data
Sep. 25, 2020 (CN) 202011027276.0

(51) Int. Cl. G08G 1/01; G06K 9/62; G06N 3/04; G06N 3/08

(52) U.S. Cl. CPC G08G 1/0129; G08G 1/0133; G06N 3/08; G06K 9/6223; G06N 3/0454; G06K 9/6226

(57) ABSTRACT

A traffic pattern prediction method, device, server, system, and a computer-readable medium are provided. The method includes: acquiring historical traffic volume data of a target block within a target geographic region, and determining a traffic pattern change sequence of the target block based on the historical traffic volume data; acquiring historical point-of-interest data of multiple point-of-interest categories of the target block, and determining, for at least one point-of-interest category of the multiple point-of-interest categories, a point-of-interest change sequence of the target block based on the historical point-of-interest data; determining, for the at least one point-of-interest category, an association between the traffic pattern change sequence and the point-of-interest change sequence; and determining, based on using a traffic pattern prediction model, a traffic pattern of the target block at a future target moment based on the historical traffic volume data, the historical point-of-interest data, and the association.

### CROSS-REFERENCE TO RELATED APPLICATION

This application claims priority to and benefits of Chinese Patent Application No. CN2020110272760.0, filed on Sep. 25, 2020, the entire content of which is incorporated herein by reference.

### TECHNICAL FIELD

The present disclosure relates to the field of computer technologies, and more particularly, to a traffic pattern prediction method and device, such as a server and a computer readable storage medium.

### BACKGROUND

The incoming and outgoing traffic pattern is a relatively coarse-grained knowledge that reflects people's travel behavior. In the related art, the traffic volume prediction method can merely predict the traffic volume value at a certain future moment, and cannot be applied to traffic volume pattern prediction.

### SUMMARY

According to an aspect of embodiments of the present disclosure, a traffic pattern prediction method is provided, which includes: acquiring historical traffic volume data of a target block within a target geographic region; determining a traffic pattern change sequence of the target block based on the historical traffic volume data; acquiring historical point-of-interest data of multiple point-of-interest categories of the target block; determining, for at least one point-of-interest category of the multiple point-of-interest categories, a point-of-interest change sequence of the target block based on the historical point-of-interest data; determining, for the at least one point-of-interest category, an association between the traffic pattern change sequence and the point-of-interest change sequence; and determining, based on using a traffic pattern prediction model, a traffic pattern of the target block at a future target moment based on the historical traffic volume data, the historical point-of-interest data, and the association.

According to another aspect of embodiments of the present disclosure, a server is provided, which includes a processor; and a memory storing a program, the program including instructions that, when executed by the processor, cause the processor to execute the traffic pattern prediction method according to some embodiments of the present disclosure.

According to another aspect of embodiments of the present disclosure, a computer readable storage medium storing a program is provided, the program including instructions that, when executed by a processor of a server, cause the server to execute the traffic pattern prediction method according to some embodiments of the present disclosure.

### BRIEF DESCRIPTION OF THE DRAWINGS

The drawings, which exemplarily illustrate embodiments and constitute a part of the specification, together with the text description of the specification, serve to explain exemplary implementations of the embodiments. The illustrated embodiments are for illustrative purposes only and do not limit the scope of the claims. Throughout the drawings, the same reference signs denote similar but not necessarily the same elements.

FIG. 1 is a schematic diagram illustrating an exemplary system in which various methods can be implemented according to some embodiments of the present disclosure;

FIG. 2 is a flowchart illustrating a traffic pattern prediction method according to some embodiments of the present disclosure;

FIG. 3 is a schematic diagram illustrating a traffic volume pattern sequence according to some embodiments of the present disclosure;

FIG. 4 is a schematic diagram illustrating a traffic volume pattern change sequence according to some embodiments of the present disclosure;

FIG. 5 is a schematic diagram illustrating a point-of-interest change sequence for a point-of-interest category according to some embodiments of the present disclosure;

FIG. 6 is a schematic diagram illustrating a traffic pattern prediction method according to some embodiments of the present disclosure;

FIG. 7 is a block diagram illustrating a traffic pattern prediction device according to some embodiments of the present disclosure; and

FIG. 8 is a block diagram illustrating an exemplary server and client applicable to implement some embodiments of the present disclosure.

### DETAILED DESCRIPTION

In order to enable those skilled in the art to better understand the solution of the present disclosure, the technical solutions of embodiments of the present disclosure will be described clearly and comprehensively with reference to the drawings in the embodiments of the present disclosure. The described embodiments are merely part of the embodiments of the present disclosure, rather than all of the embodiments. Based on the embodiments of the present disclosure, all the other embodiments that could be obtained by those skilled in the art without paying creative labor shall fall into the protection scope of the present disclosure.

The terms “first” and “second” and the like in the description, claims and drawings of the present disclosure are used to distinguish similar objects, and are not necessarily used to describe a specific sequence or order. It should be understood that, the numbers used in this way may be interchanged under appropriate circumstances so that the embodiments of the present disclosure described herein can be implemented in a sequence other than those illustrated or described herein. In addition, the terms “including” and “having” and any variations thereof are intended to cover non-exclusive inclusions. For example, the process, method, system, product or device that includes a series of steps or units is not necessarily limited to those steps or units clearly listed, but may include other steps or units that are not clearly listed or are inherent to the process, method, product or device.

Artificial intelligence technology is a comprehensive discipline, covering a wide range of fields, including both hardware-level technology and software-level technology. Basic artificial intelligence technologies generally include technologies such as sensors, dedicated artificial intelligence chips, cloud computing, distributed storage, big data processing technology, operation/interaction systems, and mechatronics. Artificial intelligence software technologies mainly include computer vision technologies speech processing technology, natural language processing technologies, and machine learning/deep learning.

The technical solutions according to embodiments of the present disclosure relate to artificial intelligence, and more particularly to traffic pattern prediction technology in the field of intelligent traffic.

To facilitate understanding embodiments of the present disclosure, the relevant technical terms involved in the present disclosure are explained below.

The target geographic region refers to the region where traffic pattern prediction is desired, it may be a certain province, a certain city, or a certain district, etc. The size of the target geographic region may be determined as needed, which is not limited in the present disclosure.

Block refers to the region enclosed by a certain level of roads. For example, the block may be a traffic community in the field of traffic planning and management. The block is often used as the basic spatial unit for research and analysis in the fields of traffic management, urban planning, and urban governance. The target block refers to the block where traffic pattern prediction is desired. The target block may be, e.g., a community, a school, an industrial park, etc.

Traffic volume may include the traffic flow out of the block in a certain time period, the traffic flow into the block in a certain time period, or the sum of the traffic flow out of the block and the traffic flow into the block in a certain time period. The traffic flow here may include pedestrian traffic, vehicle traffic, mobile device traffic, etc. The present disclosure does not make any limitation on the corresponding object of the traffic volume.

Point of interest (POI) refers to the geographic information point marked on the electronic map, which may be used to find landmarks or buildings. In the real world, there may be many different categories of POI, such as shopping mall, food shops, hotels, and transportation facilities, etc.

Graph convolutional network (GCN) is a deep learning network, which can be applicable to processing objects in the non-European space.

In the related art, the method for predicting traffic volume of the region can merely predict the traffic volume value at a certain future moment, and the prediction process merely uses historical traffic volume data of the region. Evolution of urban region will be accompanied by the change of traffic, and the change of traffic will also react on the development of the urban region. At present, there is no related method for predicting the traffic volume pattern of the region at the future moment by using data such as functional data of the region.

Accordingly, embodiments of the present disclosure provide a traffic pattern prediction method, the association between traffic volume and POI is applied to the process of predicting the traffic pattern of the region, such that the observation scale between the fine-grained traffic change and coarse-grained function evolution of the region is aligned, and the prediction of the traffic pattern of region at the future moment is achieved. Embodiments of the present disclosure will be described in detail below with reference to the accompanying drawings.

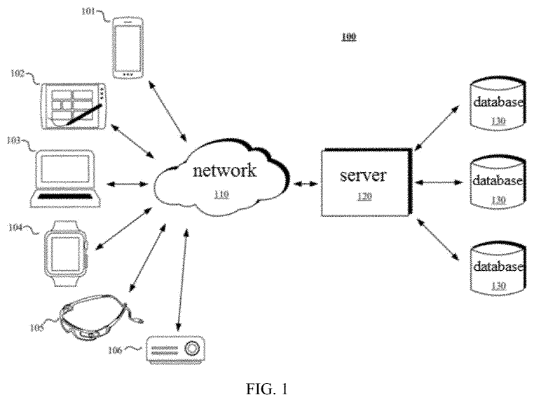

FIG. 1 is a schematic diagram illustrating an exemplary system 100 in which various methods described herein can be implemented according to some embodiments of the present disclosure. Referring to FIG. 1, the system 100 includes one or more client devices 101, 102, 103, 104, 105 and 106, a server 120, and one or more communication networks 110 that couple the one or more client devices to the server 120. The client devices 101, 102, 103, 104, 105, and 106 may be configured to execute one or more application programs.

In embodiments of the present disclosure, the server 120 may further provide other services or software applications that may include the non-virtual environment and the virtual environment. In some embodiments, these services may be provided as web-based services or cloud services, for example, to users of the client devices 101, 102, 103, 104, 105 and/or 106 under the software as a service (SaaS) model. In the configuration illustrated in FIG. 1, the server 120 may include one or more components that implement functions performed by the server 120. These components may include software components, hardware components, or a combination thereof that can be executed by one or more processors. The user operating the client devices 101, 102, 103, 104, 105 and/or 106 may use one or more client applications in sequence to interact with the server 120, to utilize the services provided by these components. It should be understood that various system configurations are possible, which may be different from that of the system 100. Therefore, FIG. 1 is an example of the system for implementing various methods described herein, and is not intended to limit it.

The user may use the client devices 101, 102, 103, 104, 105 and/or 106 to acquire historical traffic volume data and historical point-of-interest data of the target block. The client devices may provide an interface that enables the user of the client devices to interact with the client devices. The client devices may further output information to the user via the interface. Although FIG. 1 only depicts six client devices, those skilled in the art will understand that the present disclosure may support any number of client devices.

The client devices 101, 102, 103, 104, 105 and/or 106 may include various types of computing systems, such as portable handheld devices, general-purpose computers (such as personal computers and laptop computers), workstation computers, wearable devices, game systems, thin clients, various message transceiving devices, sensors or other sensing devices, etc. These computing devices may run various types and versions of software applications and operating systems, such as MICROSOFT Windows, APPLE iOS, UNIX-like operating systems, LINUX or LINUX-like operating systems (e.g., GOOGLE Chrome OS); or include various mobile operating systems, such as MICROSOFT Windows Mobile OS, iOS, WINDOWS Phone, and ANDROID. The portable handheld devices may include cellular phones, smart phones, tablet computers, personal digital assistants (PDAs) and the like. The wearable devices may include head-mounted displays and other devices. The game systems may include various handheld game devices, Internet-enabled game devices and the like. The client devices can execute various applications, such as various Internet-related applications, communication applications (such as email applications), and short message service (SMS) applications, and may use various communication protocols.

Network 110 may be any type of networks well known to those skilled in the art, and may use any one of a variety of protocols available (including but not limited to TCP/IP, SNA, IPX, etc.) to support data communication. For example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth, WIFI) and/or any combination of these and/or other networks.

The server 120 may include one or more general-purpose computers, dedicated server computers (e.g., PC (personal computer) servers, UNIX servers, mid-range servers), blade-type servers, mainframe computers, server clusters, or any other suitable arrangements and/or combinations. The server 120 may include one or more virtual machines running a virtual operating system, or other computing architectures involving virtualization (e.g., one or more flexible pools of logical storage devices that may be virtualized to maintain virtual storage devices of the server). In various embodiments, the server 120 may run one or more services or software applications that provide the functions described below.

The computing system in the server 120 may run one or more operating systems including any of the above operating systems and any server operating systems commercially available. The server 120 may further run any of various additional server applications and/or middle tier applications, including a hypertext transfer protocol (HTTP) server, a file transfer protocol (FTP) server, a common gateway interface (CGI), a JAVA server, a database server, etc.

In some embodiments, the server 120 may include one or more applications to analyze and merge data feed and/or event update received from the user of the client devices 101, 102, 103, 104, 105 and 106. The server 120 may further include one or more applications to display data feed and/or real-time event via one or more display devices of the client devices 101, 102, 103, 104, 105 and 106.

The system 100 may further include one or more databases or data repositories 130. In some embodiments, these databases may be used to store data and other information. For example, one or more of the databases 130 may be used to store information such as audio files and video files. The data repositories 130 may reside in various locations. For example, the data repository used by the server 120 may be local to the server 120, or may be remote from the server 120 and may be in communication with the server 120 via the network-based or dedicated connection. The data repositories 130 may be of different types. In some embodiments, the data repository used by the server 120 may be a database, e.g., a relational database. One or more of these databases may store, update, and retrieve the databases and data from the databases in response to commands.

In some embodiments, one or more of the databases 130 may further be used by applications to store application data. The databases used by the applications may be different types of databases, such as a key-value repository, an object repository, or a conventional repository supported by a file system.

The system 100 illustrated in FIG. 1 may be configured and operated in various ways to enable application of the various methods and devices according to the present disclosure. It should be understood that, the system 100 illustrated in FIG. 1 is merely an example, and the system to which the traffic pattern prediction method according to the embodiments of the present disclosure is applicable is not limited herein.

FIG. 2 is a flowchart illustrating a traffic pattern prediction method 200 according to some embodiments of the present disclosure. As illustrated in FIG. 2, the method 200 may include: acquiring historical traffic volume data of a target block within a target geographic region, and determining a traffic pattern change sequence of the target block based on the historical traffic volume data (block 201); acquiring historical point-of-interest data of multiple point-of-interest categories of the target block, and determining, for at least one point-of-interest category of the plurality of point-of-interest categories, a point-of-interest change sequence of the target block based on the historical point-of-interest data (block 202); determining, for the at least one point-of-interest category, an association between the traffic pattern change sequence and the point-of-interest change sequence(block 203); and determining, based on using a traffic pattern prediction model, a traffic pattern of the target block at a future target moment based on the historical traffic volume data, the historical point-of-interest data, and the association (block 204). Thereby, the association between traffic volume and POI is applied to predict the traffic pattern of the region, such that the observation scale between the fine-grained traffic change and coarse-grained function evolution of the region is aligned, and the prediction of the traffic pattern of region at the future moment is achieved.

In some examples, the historical traffic volume data and the historical point-of-interest data of the target region may be acquired from a map database. For the target geographic region (such as a city) where traffic pattern prediction is desired, the city may be divided into multiple blocks based on road network information.

In some embodiments, the historical traffic volume data of the target block includes historical traffic volume data of the target block in a first target period. The first target period may include but is not limited to, e.g., several months, one year, two years, etc. Determining the traffic pattern change sequence of the target block based on the historical traffic volume data may include: acquiring a basic traffic volume sequence, the basic traffic volume sequence being constructed based on the historical traffic volume data of the target block in the first target period, and the basic traffic volume sequence comprising multiple basic traffic volume sequences; clustering the multiple basic traffic volume sequences to acquire a traffic pattern sequence; and determining the traffic pattern change sequence based on the traffic pattern sequence.

In some embodiments, clustering the multiple basic traffic volume sequences to acquire the traffic pattern sequence may include: determining a traffic pattern label corresponding to each of the multiple basic traffic volume sequences based on a preset clustering algorithm; and constructing the traffic pattern sequence based on the traffic pattern label. Thereby, by constructing and clustering the basic traffic sequence, the traffic pattern sequence is obtained, such that data dimension can be reduced, and data processing efficiency can be improved.

In some examples, the traffic pattern sequence includes multiple traffic pattern sequences. Determining the traffic pattern change sequence based on the traffic pattern sequence may include: determining a similarity between adjacent two traffic pattern sequences of the multiple traffic pattern sequences; and constructing the traffic pattern change sequence based on the similarity. Thereby, by constructing the traffic pattern change sequence, the predicted traffic model can be more real and fit the reality, and the real prediction of the traffic pattern of the region in the future moment can be achieved.

In an example, the traffic volume data of the target block for one day (24 hours) may be taken as a basic traffic volume sequence, e.g., Xᵢ=(x₁, x₂, . . . , x₂₄), each component xᵢ (i=1, 2, . . . , 24) of the basic traffic volume sequence represents the traffic volume of the target block in an hour. The traffic volume data of the target block for n weeks may then include n×7 basic traffic volume sequences. The length of each of the basic traffic volume sequences is 24.

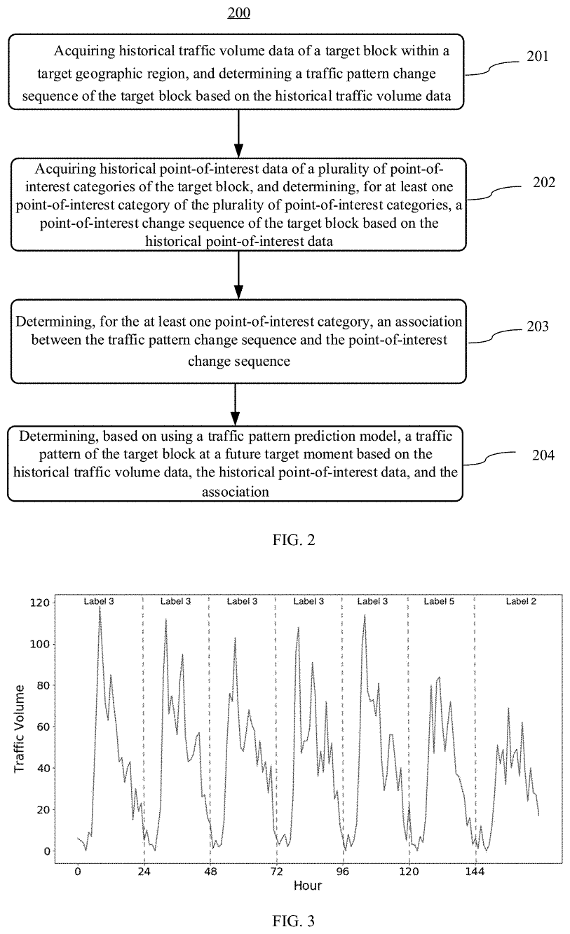

In an example, the preset clustering algorithm may include the K-spectrum clustering (K-SC) algorithm. The multiple basic traffic volume sequences may be clustered by using the K-SC algorithm to determine the traffic pattern label corresponding to each of the multiple basic traffic volume sequences, and the traffic pattern sequence can be constructed based on the traffic pattern label acquired. For example, n×7 basic traffic volume sequences may have n×7 traffic pattern labels, and every 7 traffic pattern labels may form a traffic pattern sequence, such as (y₁, y₂, . . . , y₇), and n traffic pattern sequences can be obtained. The length of the traffic pattern sequence is 7, and each component yᵢ (i=1, 2, . . . , 7) represents the traffic volume pattern of the target block for one day. In some examples, the traffic volume pattern may include, but is not limited to, e.g., a morning peak pattern, an evening peak pattern, or a morning and evening peak pattern. As illustrated in FIG. 3, it illustrates the traffic volume sequences of a certain block for one week (7 days).

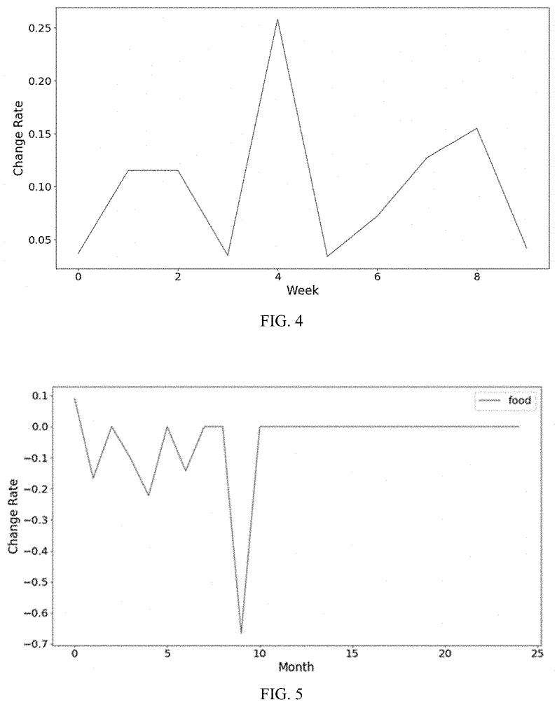

In an example, the similarity between adjacent two traffic pattern sequences in the n traffic pattern sequences may be calculated, and the traffic pattern change sequence may be constructed based on the similarity. For example, when n=4, the similarity between adjacent two traffic pattern sequences in the 4 traffic pattern sequences may be calculated to obtain 3 similarity values, and the traffic pattern change sequence, e.g., (z₁, z₂, z₃) can be formed based on the 3 similarity values. The length of the traffic pattern change sequence is 3, and each component zᵢ (i=1, 2, 3) represents the traffic pattern change of the target block in adjacent two weeks. In some examples, the similarity may be a distance, including but not limited to the Euclidean distance or the cosine distance. As illustrated in FIG. 4, it illustrates a traffic pattern change sequence of a certain block.

The process of clustering multiple basic traffic volume sequences by using the K-SC algorithm may include the following steps: a) taking N basic traffic volume sequences Xᵢ (i=1, 2, . . . , N) as the input; b) randomly dividing the N basic traffic volume sequences into K categories; c) determining a matrix

$$M = {Σ}_{{x}_{i} ∈ {C}_{k}} ( I - \frac{{x}_{i} {x}_{i}^{T}}{{‖ {x}_{i} ‖}^{2}} )$$

for each of the categories, where

I represents the unit matrix, and calculating feature vectors of the matrix M, and taking the feature vector corresponding to the minimum feature value as the center of the category; d) updating the center of each of the categories, calculating the distance from each data to the center of each of the categories, and dividing the data into the category with the minimum distance; and repeating steps c) and d) until the classification result does not change.

In some embodiments, the historical point-of-interest data includes historical point-of-interest data of the target block in a second target period for multiple point-of-interest categories. The second target period may include but is not limited to, e.g., several months, one year, two years, etc. The first target period may be the same as or different from the second target period, which is not limited in the present disclosure. Determining the point-of-interest change sequence of the target block based on the historical point-of-interest data may include: acquiring, for a same point-of-interest category, the number of points of interest of the target block in a preset sampling period; and performing differential processing on the number of points of interest in adjacent two preset sampling periods to acquire the point-of-interest change sequence. Thereby, through differential processing, the processed data is more realistic, and the real prediction of the traffic pattern of the region at the future moment can be achieved.

In some examples, the preset sampling period may include, e.g., one month, two months. For the same point-of-interest category, the number of the points of interest in adjacent two months may be differentiated, and the difference can form a point-of-interest change sequence. As illustrated in FIG. 5, it illustrates a point-of-interest change sequence of the food category of a certain block.

In some embodiments, determining the association between the traffic pattern change sequence and the point-of-interest change sequence may include: extracting a sub traffic pattern change sequence of the traffic pattern change sequence via a sliding window; extracting a sub point-of-interest change sequence of the point-of-interest change sequence via the sliding window, the length of the sub traffic pattern change sequence being equal to the length of the sub point-of-interest change sequence; calculating a mutual information entropy between the sub traffic pattern change sequence and the sub point-of-interest change sequence; and determining the association between the traffic pattern change sequence and the point-of-interest change sequence based on the mutual information entropy. Thereby, by the sliding window, the traffic pattern change sequence and the point-of-interest change sequence of the same length are extracted, the observation scale between the fine-grained traffic change and coarse-grained function evolution of the region is aligned, and the traffic pattern prediction of the region at the future moment is achieved.

In some embodiments, the sub traffic pattern change sequence corresponds to a first time stamp, the sub point-of-interest change sequence corresponds to a second time stamp, and the interval between the first time stamp and the second time stamp is less than the preset interval. The preset interval may be, e.g., three months. By defining the time interval, the sub traffic pattern change sequence and the sub traffic pattern change sequence may correspond to each other in time, so as to improve the accuracy of the traffic pattern prediction.

In some embodiments, the method of embodiments of the present disclosure may further include: constructing, for at least one point-of-interest category, at least one association matrix for characterizing the association between the traffic pattern change sequence and the point-of-interest change sequence based on the association between the traffic pattern change sequence and the point-of-interest change sequence; and performing first preset processing on the at least one association matrix to acquire a first characterization for characterizing the interaction between traffic volume and point-of-interest evolution of the target block. In some examples, the first preset processing may include convolution operation processing and weighted aggregation processing of gated mechanism. The convolution processing and weighted aggregation of gated mechanism may be performed on the at least one association matrix to acquire the first characterization for characterizing the interaction between the traffic volume and the point-of-interest evolution of the target block.

In some embodiments, the method of embodiments of the present disclosure may further include: acquiring multiple blocks associated with the target block based on the historical traffic volume data, the target block and one of the multiple blocks forming the start point and the end point of the travel behavior; constructing the graph convolutional network based on the topological relationship graph between the target block and the multiple blocks, the graph convolutional network including multiple graph convolutional networks, and the multiple graph convolutional networks corresponding to the same first time segment; and associating the multiple graph convolutional networks to acquire a second characterization for characterizing the traffic volume of the target block. By fusing the target region and its associated regions, it is more suitable to the actual situation, such that real prediction of the traffic pattern of the region at the future moment can be achieved.

In some examples, the travel relationship between blocks may constitute a topological relationship graph. For example, for the topological relationship graph of the target block A, the nodes of the topological relationship graph are the target block A and the blocks that have the travel relationship with the target block A, and the edges thereof represent the connection relationship between the blocks (e.g., starting from the target block A to one of the block B, or starting from another block to the target block A), the weight of the edge indicates the frequency of the travel behavior (e.g., when it is started from the target block A to the block B twice, the weight of the edge connecting the target block A and the block B is 2). Based on the historical traffic volume data, and by the travel relationship between blocks (i.e., the topological relationship graph), the static graph convolutional network may be constructed. Each graph convolutional network constructed may correspond to the first time segment, such as one week, one month, etc., which is not limited in the present disclosure. For example, when the first time segment is one week, 4 corresponding graph convolutional networks may be constructed based on traffic volume data of the target block for one month. These graph convolutional networks may be associated through an attention mechanism to acquire the second characterization for characterizing the traffic volume of the target block.

In some embodiments, the method of embodiments of the present disclosure may further include: constructing a point-of-interest sequence based on the historical point-of-interest data, the point-of-interest sequence including multiple point-of-interest sequences, and the multiple point-of-interest sequences corresponding to the same second time segment; and performing second preset processing on the point-of-interest sequence to acquire a third characterization for characterizing point-of-interest evolution of the target block. The second time segment may be, e.g., one week, one month, etc., which is not limited in the present disclosure. The third characterization for characterizing point-of-interest evolution of the target block may be acquired based on the gated recurrent unit (GRU) and multi-layer perceptron (MLP) of the gated mechanism.

In some embodiments, determining the traffic pattern of the target block at the future target moment based on the historical traffic volume data, the historical point-of-interest data and the association by using the traffic pattern prediction model may include: aggregating the second characterization and the third characterization to acquire an aggregated fourth characterization for characterizing the traffic volume of the target block; splicing the fourth characterization and the first characterization to acquire fused characterization; and determining the traffic pattern of the target block at the future target moment based on the fused characterization by using the traffic pattern prediction model. In some embodiments, the traffic pattern prediction model is used, and the traffic pattern prediction model includes a full connected layer. The traffic pattern of the target block at the future target moment is output via the full connected layer.

In some examples, the pooling operation may be performed on the second characterization and the third characterization, respectively, and the pooled second characterization and the pooled third characterization may be then aggregated by the attention mechanism to obtain the aggregated fourth characterization. The fourth characterization and the first characterization may be spliced, and the traffic pattern of the target block at the future target moment (for example, t+1 days in the future) can be output through the full connected layer of the traffic pattern prediction model. In some other examples, through end-to-end learning, the association between the function evolution and the traffic may also be output while predicting the traffic pattern for t+1 days in the future, so as to further provide basis for exploring the law of interaction between the traffic volume and the function evolution.

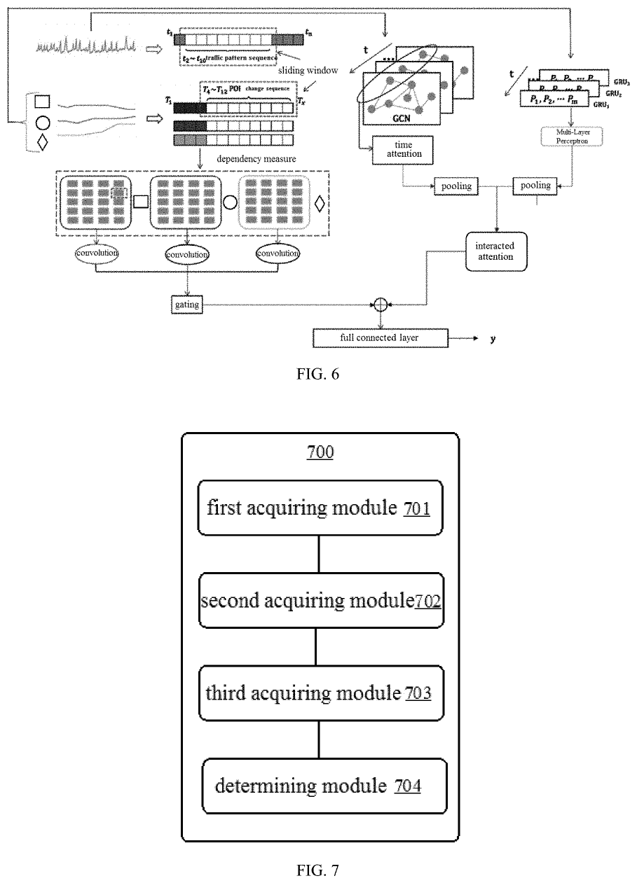

FIG. 6 is a schematic diagram illustrating a traffic pattern prediction method according to some embodiments of the present disclosure. The traffic pattern prediction method illustrated in FIG. 6 may be an example of the above traffic pattern prediction method.

The traffic pattern prediction method according to embodiments of the present disclosure are described above. Although various operations are depicted in the specific order in the drawings, it should not be construed as requiring that these operations must be performed in the specific order shown or in the sequential order, nor should it be construed as requiring that all the operations must be performed to achieve desired results.

A traffic pattern prediction device according to embodiments of the present disclosure will be described below. FIG. 7 is a block diagram illustrating a traffic pattern prediction device 700 according to some embodiments of the present disclosure. As illustrated in FIG. 7, the device 700 includes a first acquiring module 701, a second acquiring module 702, a third acquiring module 703, and a determining module 704.

The first acquiring module 701 is configured to acquire historical traffic volume data of a target block within a target geographic region, and to determine a traffic pattern change sequence of the target block based on the historical traffic volume data.

The second acquiring module 702 is configured to acquire historical point-of-interest data of multiple point-of-interest categories of the target block, and to determine, for at least one point-of-interest category of the multiple point-of-interest categories, a point-of-interest change sequence of the target block based on the historical point-of-interest data.

The third acquiring module 703 is configured to determine, for the at least one point-of-interest category, an association between the traffic pattern change sequence and the point-of-interest change sequence.

The determining module 704 is configured to determine, based on using a traffic pattern prediction model, a traffic pattern of the target block at a future target moment based on the historical traffic volume data, the historical point-of-interest data, and the association.

With the traffic pattern prediction device according to embodiments of the present disclosure, the association between traffic volume and POI is applied to the process of predicting the traffic pattern of the region, such that the observation scale between the fine-grained traffic change and coarse-grained function evolution of the region is aligned, and the prediction of the traffic pattern of region at the future moment is achieved.

Although specific functions are discussed above with reference to specific modules, it should be noted that functions of various modules discussed herein may be divided into multiple modules, and/or at least some of the functions of the multiple modules may be combined into a single module. The specific module executing an act discussed herein includes the specific module itself performing the act, or alternatively the specific module calling or otherwise accessing another component or module that performs the act in other manners (or performs the act in combination with the specific module). Therefore, the specific module that performs an act may include the specific module itself that performs an act and/or another module that is called or accessed by the specific module to perform an act.

More generally, various techniques may be described herein in the general context of software and hardware elements or program modules. Various modules described above in FIG. 7 may be implemented in hardware or in hardware combined with software and/or firmware. For example, these modules may be implemented as computer program codes/instructions configured to be executed in one or more processors and stored in a computer readable storage medium. Alternatively, these modules may be implemented as hardware logic/circuitry. For example, in some embodiments, one or more of the first acquiring module 701, the second acquiring module 702, the third acquiring module 703, and the determining module 704 may be implemented together in a system on chip (SoC). The SoC may include an integrated circuit chip (which includes a processor (e.g., a central processing unit (CPU), a microcontroller, a microprocessor, a digital signal processor (DSP), etc.), a memory, one or more communication interfaces, and/or one or more components in other circuits), and may optionally execute program codes received and/or include embedded firmware to execute functions.

According to another aspect of the present disclosure, a server is further provided, which may include: a processor; and a memory storing a program, the program including instructions that, when executed by the processor, cause the processor to execute the above traffic pattern prediction method.

According to another aspect of the present disclosure, a computer readable storage medium storing a program is further provided. The program may include instructions that, when executed by the processor of the server, cause the server to execute the above traffic pattern prediction method.

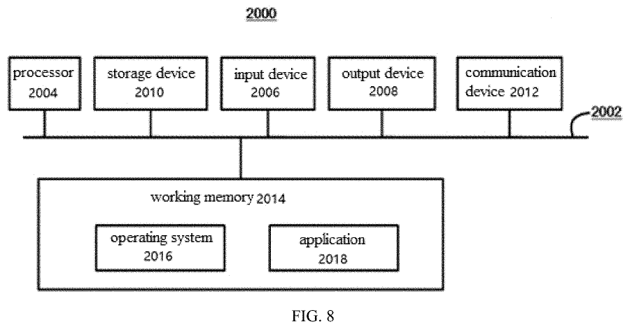

Referring to FIG. 8, a block diagram of a computing device 2000 that can be used as a server or a client of the present disclosure will now be described, which is an example of the hardware device that can be applied to various aspects of the present disclosure.

The computing device 2000 may include elements connected to or being in communication with a bus 2002 (possibly via one or more interfaces). For example, the computing device 2000 may include the bus 2002, one or more processors 2004, one or more input devices 2006, and one or more output devices 2008. The one or more processors 2004 may be any type of processors, and may include, but are not limited to, one or more general-purpose processors and/or one or more dedicated processors (e.g., special processing chips). The processors 2004 may process instructions executed in the computing device 2000, including instructions stored in or on the memory to display graphical information of graphical user interface (GUI) on an external input/output device (e.g., a display device coupled to an interface). In other embodiments, multiple processors and/or multiple buses and multiple memories may be used together with multiple memories under different circumstances. Similarly, multiple computing devices may be connected, and each of the devices provides part of the operations (e.g., as a server array, a group of blade-type servers, or a multi-processor system). In FIG. 8, one processor 2004 is taken as an example.

The input devices 2006 may be any type of devices capable of inputting information to the computing device 2000, and may include, but are not limited to, a mouse, a keyboard, a touch screen, a trackpad, a trackball, a joystick, a microphone, and/or a remote control. The output devices 2008 may be any type of devices that can present information, and may include, but are not limited to, a display, a speaker, a video/audio output terminal, a vibrator, and/or a printer.

The computing device 2000 may further include a non-transitory storage device 2010 or be connected to the non-transitory storage device 2010. The non-transitory storage device may be any storage device that is non-transitory and can realize data storage, and may include, but is not limited to, a disk drive , an optical storage device, a solid-state memory, a floppy disk, a flexible disk, a hard disk, a magnetic tape or any other magnetic medium, an optical disk or any other optical medium, an ROM (read only memory), an RAM (random access memory), a cache memory and/or any other memory chip or cartridge, and/or any other medium from which the computer can read data, instructions, and/or codes. The non-transitory storage device 2010 may be detached from the interface. The non-transitory storage device 2010 may have data/programs (including instructions)/codes/modules (the first acquiring module 701, the second acquiring module 702, the third acquiring module 703, and the determining module 704) for implementing the above method and steps.

The computing device 2000 may further include a communication device 2012. The communication device 2012 may be any type of device or system that enables communication with external devices and/or with the network, and may include, but is not limited to, a modem, a network card, an infrared communication device, a wireless communication device, and/or a chipset, such as a BLUETOOTH™ device, a 1302.11 device, a WiFi device, a WiMax device, a cellular communication device and/or the like.

The computing device 2000 may further include a working memory 2014, which may be any type of working memory that can store programs (including instructions) and/or data useful for the work of the processors 2004, and may include, but is not limited to, a random-access memory and /or a read only memory device.

The software elements (programs) may be located in the working memory 2014, and include, but are not limited to, an operating system 2016, one or more applications 2018, drivers, and/or other data and codes. Instructions for executing the above method and steps may be included in the one or more applications 2018, and the above method may be implemented by the processors 2004 reading and executing instructions of the one or more applications 2018. The executable codes or source codes of the instructions of the software elements (programs) may also be downloaded from a remote position.

It should be further understood that various modifications may be made according to different circumstances. For example, customized hardware may also be used, and/or hardware, software, firmware, middleware, microcode, hardware description language, or any combinations thereof may be used to realize specific elements. For example, some or all of the disclosed methods and devices may be realized by programming hardware (e.g., a programmable logic circuit including a field programmable gate array (FPGA) and/or a programmable logic array (PLA)) in an assembly language or a hardware programming language (e.g., VERILOG, VHDL, and C++) according to the logic and algorithm of the present disclosure.

It should be further understood that the above method may be implemented in a server-client mode. For example, the client may receive data input by the user and send the data to the server. The client may also receive data input by the user, perform part of the processing in the above method, and send the processed data to the server. The server may receive data from the client, execute the above method or the other part of the above method, and return execution results to the client. The client may receive the execution results of the method from the server, and may present the execution results to the user via, e.g., an output device. The client and the server are generally far away from each other and usually interact via the communication network. The relationship between the client and the server is generated by computer programs running on the corresponding computing devices and having a client-server relationship with each other. The server may be a server of a distributed system or a server combined with a blockchain. The server may also be a cloud server, or a smart cloud computing server or smart cloud host with artificial intelligence technology.

It should be further understood that components of the computing device 2000 may be distributed over the network. For example, one processor may be used to perform some processing, while another processor remote from the one processor may perform other processing. Other components of the computing device 2000 may also be similarly distributed. In this way, the computing device 2000 can be interpreted as a distributed computing system that performs processing in multiple positions.

Although the embodiments or examples of the present disclosure have been described with reference to the accompanying drawings, it should be understood that the above methods, systems, and devices are merely exemplary embodiments or examples, and the scope of the present disclosure is not limited by these embodiments or examples, but limited only by the Claims that has been granted a patent right and its equivalent scope. Various elements in the embodiments or examples may be omitted or replaced by equivalent elements. In addition, the steps may be performed in an order different from that described in the present disclosure. Further, various elements in the embodiments or examples may be combined in various ways. What is important is that as technology evolves, many elements described herein may be replaced by equivalent elements appearing after this disclosure.

What is claimed is:

1. A method, comprising:
acquiring historical traffic volume data of a target block within a target geographic region;
determining a traffic pattern change sequence of the target block based on the historical traffic volume data;
acquiring historical point-of-interest data of a plurality of point-of-interest categories of the target block;
determining, for at least one point-of-interest category of the plurality of point-of-interest categories, a point-of-interest change sequence of the target block based on the historical point-of-interest data;
determining, for the at least one point-of-interest category, an association between the traffic pattern change sequence and the point-of-interest change sequence; and
determining, based on using a traffic pattern prediction model, a traffic pattern of the target block at a future target moment based on the historical traffic volume data, the historical point-of-interest data, and the association.

2. The method according to claim 1, further comprising:
constructing, for the at least one point-of-interest category, at least one association matrix for characterizing the association between the traffic pattern change sequence and the point-of-interest change sequence based on the association between the traffic pattern change sequence and the point-of-interest change sequence; and
performing first preset processing on the at least one association matrix to acquire a first characterization for characterizing an interaction between traffic volume and point-of-interest evolution of the target block.

3. The method according to claim 1, further comprising:
acquiring a plurality of blocks associated with the target block based on the historical traffic volume data, wherein the target block and one of the plurality of blocks form a start point and an end point of a travel behavior;
constructing a graph convolutional network based on a topological relationship graph between the target block and the plurality of blocks, wherein the graph convolutional network comprises a plurality of graph convolutional networks, and the plurality of graph convolutional networks correspond to a same first time segment; and
associating the plurality of graph convolutional networks to acquire a second characterization for characterizing traffic volume of the target block.

4. The method according to claim 1, further comprising:
constructing a point-of-interest sequence based on the historical point-of-interest data, wherein the point-of-interest sequence comprises a plurality of point-of-interest sequences, and the plurality of point-of-interest sequences correspond to a same second time segment; and
performing second preset processing on the point-of-interest sequence to acquire a third characterization for characterizing point-of-interest evolution of the target block.

5. The method according to claim 1, wherein the determining the traffic pattern of the target block at the future target moment based on the historical traffic volume data, the historical point-of-interest data and the association by using the traffic pattern prediction model comprises:
aggregating the second characterization and the third characterization to acquire an aggregated fourth characterization for characterizing traffic volume of the target block;
splicing the fourth characterization and the first characterization to acquire fused characterization; and
determining the traffic pattern of the target block at the future target moment based on the fused characterization by using the traffic pattern prediction model.

6. The method according to claim 5, wherein the traffic pattern prediction model comprises a full connected layer, and wherein,
the traffic pattern of the target block at the future target moment is output via the full connected layer.

7. The method according to claim 1, wherein the historical traffic volume data comprises historical traffic volume data of the target block in a first target period, and wherein the determining the traffic pattern change sequence of the target block based on the historical traffic volume data comprises:
acquiring a basic traffic volume sequence, wherein the basic traffic volume sequence is constructed based on the historical traffic volume data of the target block in the first target period, and the basic traffic volume sequence comprises a plurality of basic traffic volume sequences;
clustering the plurality of basic traffic volume sequences to acquire a traffic pattern sequence; and
determining the traffic pattern change sequence based on the traffic pattern sequence.

8. The method according to claim 7, wherein the clustering the plurality of basic traffic volume sequences to acquire the traffic pattern sequence comprises:
determining a traffic pattern label corresponding to each of the plurality of basic traffic volume sequences based on a preset clustering algorithm; and
constructing the traffic pattern sequence based on the traffic pattern label.

9. The method according to claim 7, wherein the traffic pattern sequence comprises a plurality of traffic pattern sequences, wherein,
the determining the traffic pattern change sequence based on the traffic pattern sequence comprises:
determining a similarity between adjacent two traffic pattern sequences of the plurality of traffic pattern sequences, and constructing the traffic pattern change sequence based on the similarity.

10. The method according to claim 1, wherein the historical point-of-interest data comprises historical point-of-interest data of the target block in a second target period for the plurality of point-of-interest categories, and wherein,
the determining the point-of-interest change sequence of the target block based on the historical point-of-interest data comprises:
acquiring, for a same point-of-interest category, a number of points of interest of the target block in a preset sampling period; and
performing differential processing on the number of points of interest in adjacent two preset sampling periods to acquire the point-of-interest change sequence.

11. The method according to claim 1, wherein the determining the association between the traffic pattern change sequence and the point-of-interest change sequence comprises:
extracting a sub traffic pattern change sequence of the traffic pattern change sequence via a sliding window;
extracting a sub point-of-interest change sequence of the point-of-interest change sequence via the sliding window, wherein a length of the sub traffic pattern change sequence is equal to a length of the sub point-of-interest change sequence;
calculating a mutual information entropy between the sub traffic pattern change sequence and the sub point-of-interest change sequence; and
determining the association between the traffic pattern change sequence and the point-of-interest change sequence based on the mutual information entropy.

12. The method according to claim 11, wherein the sub traffic pattern change sequence corresponds to a first time stamp, and the sub point-of-interest change sequence corresponds to a second time stamp, and wherein,
an interval between the first time stamp and the second time stamp is less than a preset interval.

13. A server, comprising:
a processor; and
a non-transitory memory storing a program, the program comprising instructions that, when executed by the processor, cause the processor to:
acquire historical traffic volume data of a target block within a target geographic region;
determine a traffic pattern change sequence of the target block based on the historical traffic volume data;
acquire historical point-of-interest data of a plurality of point-of-interest categories of the target block;
determine, for at least one point-of-interest category of the plurality of point-of-interest categories, a point-of-interest change sequence of the target block based on the historical point-of-interest data;
determine, for the at least one point-of-interest category, an association between the traffic pattern change sequence and the point-of-interest change sequence; and
determine, based on using a traffic pattern prediction model, a traffic pattern of the target block at a future target moment based on the historical traffic volume data, the historical point-of-interest data, and the association.

14. The server according to claim 13, wherein the instructions that, when executed by the processor, further cause the processor to:
construct, for the at least one point-of-interest category, at least one association matrix for characterizing the association between the traffic pattern change sequence and the point-of-interest change sequence based on the association between the traffic pattern change sequence and the point-of-interest change sequence; and
perform first preset processing on the at least one association matrix to acquire a first characterization for characterizing an interaction between traffic volume and point-of-interest evolution of the target block.

15. The server according to claim 13, wherein the instructions that, when executed by the processor, further cause the processor to:
acquire a plurality of blocks associated with the target block based on the historical traffic volume data, wherein the target block and one of the plurality of blocks form a start point and an end point of a travel behavior;
construct a graph convolutional network based on a topological relationship graph between the target block and the plurality of blocks, wherein the graph convolutional network comprises a plurality of graph convolutional networks, and the plurality of graph convolutional networks correspond to a same first time segment; and
associate the plurality of graph convolutional networks to acquire a second characterization for characterizing traffic volume of the target block.

16. The server according to claim 13, wherein the instructions that, when executed by the processor, further cause the processor to:
construct a point-of-interest sequence based on the historical point-of-interest data, wherein the point-of-interest sequence comprises a plurality of point-of-interest sequences, and the plurality of point-of-interest sequences correspond to a same second time segment; and
perform second preset processing on the point-of-interest sequence to acquire a third characterization for characterizing point-of-interest evolution of the target block.

17. The server according to claim 13, wherein the instructions that, when executed by the processor, further cause the processor to:
aggregate the second characterization and the third characterization to acquire an aggregated fourth characterization for characterizing traffic volume of the target block;
splice the fourth characterization and the first characterization to acquire fused characterization; and
determine the traffic pattern of the target block at the future target moment based on the fused characterization by using the traffic pattern prediction model.

18. The server according to claim 17, wherein the traffic pattern prediction model comprises a full connected layer, and wherein,
the traffic pattern of the target block at the future target moment is output via the full connected layer.

19. The server according to claim 13, wherein the historical traffic volume data comprises historical traffic volume data of the target block in a first target period, and,
wherein the instructions that, when executed by the processor, further cause the processor to:
acquire a basic traffic volume sequence, wherein the basic traffic volume sequence is constructed based on the historical traffic volume data of the target block in the first target period, and the basic traffic volume sequence comprises a plurality of basic traffic volume sequences;
cluster the plurality of basic traffic volume sequences to acquire a traffic pattern sequence; and
determine the traffic pattern change sequence based on the traffic pattern sequence.

20. A non-transitory computer readable storage medium storing a program, the program comprising instructions that, when executed by a processor of a server, cause the server to:
acquire historical traffic volume data of a target block within a target geographic region;
determine a traffic pattern change sequence of the target block based on the historical traffic volume data;
acquire historical point-of-interest data of a plurality of point-of-interest categories of the target block;
determine, for at least one point-of-interest category of the plurality of point-of-interest categories, a point-of-interest change sequence of the target block based on the historical point-of-interest data;
determine, for the at least one point-of-interest category, an association between the traffic pattern change sequence and the point-of-interest change sequence; and
determine, based on using a traffic pattern prediction model, a traffic pattern of the target block at a future target moment based on the historical traffic volume data, the historical point-of-interest data, and the association.
